(19) United States
(12) Patent Application Publication
(10) Pub. No.: US 2022/0114580 A1
(43) Pub. Date: Apr. 14, 2022

(54) TOKENIZED ENERGY SETTLEMENTS APPLICATION

(71) Applicant: KPMG LLP, New York, NY (US)

(72) Inventors: Abhitej Kumar Gopireddy, Walnut Creek, CA (US); Shekar Atmakur, Atlanta, GA (US); Pravin Chandran, New Smyrna Beach, FL (US); Matthew Daniel Kniess, Denver, CO (US); Soumya Shetty, San Francisco, CA (US)

(21) Appl. No.: 17/450,292

(22) Filed: Oct. 8, 2021

Related U.S. Application Data
(60) Provisional application No. 63/089,254, filed on Oct. 8, 2020.

(51) Int. Cl. G06Q 20/36; G06Q 50/06; G06Q 20/40; G06Q 20/38; G06Q 20/02

(52) U.S. Cl. CPC G06Q 20/3674; G06Q 50/06; G06Q 2220/00; G06Q 20/381; G06Q 20/02; G06Q 20/401

(57) ABSTRACT

Systems and methods disclosed herein are directed to a tokenized energy settlements application. By combining capabilities to automate reconciliation, attest to transactions, and automate payment settlements for the energy industry, an embodiment of the present invention enables organizations to accelerate their post trade processes of transaction reconciliation and payment settlement.

### CROSS REFERENCE TO RELATED APPLICATION

This patent application claims priority to U.S. Provisional Application No. 63/089,254, filed Oct. 8, 2020, the complete disclosure of which is incorporated herein by reference.

### FIELD OF THE INVENTION

The present invention relates to a scalable and advanced real-time reconciliation and settlements system and method.

### BACKGROUND

Energy retailers generally assess the demand of customers in advance for a settlement period. Once demand is calculated, an agreement may be entered with energy generation resources. Generally, suppliers assess energy demand of customers and contract for an expected energy demand. Actual consumption may be compared with actual generation or production. Settlement may be conducted to address imbalances.

Energy trading settlements teams generally spend 3-4 hours per deal matching data and identifying discrepancies. Transactions are processed manually which leads to lengthy delays. In addition, mismatches between deals and transactions will generally take 25 days or so to identify and further requires an investigation process to address. With the current process, discrepancies are not identified until a prolonged manual effort leading to a delayed reconciliation process and eventual payment.

It would be desirable, therefore, to have systems and methods to perform energy trading reconciliation and settlements on a near-daily basis.

### SUMMARY

According to an embodiment of the present invention, a system implements a tokenized energy settlements application. The system comprises: i) a first sub-system configured to capture energy deals and transactions information from both party and counterparty source systems and further configured to reconcile the information, the first sub-system comprising: a node executing software that ingests a first set of data and transactions from a party's (buyer) Energy Trading and Risk Management (ETRM) system; a node executing software that ingests a second set of data and transactions from a counterparty's (seller) ETRM system; a Private Permissioned Blockchain that receives deals and transactions data from the party; deals and transactions data from the counterparty; authenticated transaction data from a Notary Node; currency exchange rate data through a Currency Exchange Rate Oracle; and commodity exchange rate data through a Commodity Exchange Rate Oracle; and a Reconciliation Smart Contract that matches deals and transactions submitted by the party and the counterparty using the authenticated transaction data from the Notary Node to achieve consensus and emits reconciliation status to the party, the counterparty, and an Interoperability Node; ii) a second sub-system configured to attest to the data submitted by the party and the counterparty; the second sub-system comprising: the Notary Node configured to ingest authenticated transaction data from a third-party data aggregator; iii) a third sub-system configured to support payment settlements on a Public Blockchain; the third sub-system comprising: the Interoperability Node that, in response to a successful transaction reconciliation, initiates a settlement process; verifies whether the party (buyer) has sufficient funds to process the settlement; and notifies the party (buyer) of a corresponding balance; and a Custody/Institutional Wallet module configured to send a signed transaction to a Token Contract on the Public Blockchain, responsive to a request from the Interoperability Node; wherein responsive to a signed transaction from the Custody/Institutional module, the Token Contract on the Public Blockchain effectuates the settlement between the party and the counterparty.

According to another embodiment of the present invention, a method implements a tokenized energy settlements application. The method comprises the steps of: ingesting a first set of data and transactions from a party's (buyer) Energy Trading and Risk Management (ETRM) system; ingesting a second set of data and transactions from a counterparty' s (seller) ETRM system; ingesting authenticated transaction data from a third-party data aggregator; publishing to a Private Permissioned Blockchain deals and transactions data from the party; deals and transactions data from the counterparty; the authenticated transaction data from the third-party data aggregator; currency exchange rate data through a Currency Exchange Rate Oracle; commodity exchange rate data through a Commodity Exchange Rate Oracle; reconciling deals and transactions via a Reconciliation Smart Contract; using authenticated transaction data from the third-party data aggregator to achieve consensus; emitting reconciliation status to the party, the counterparty, and an Interoperability Node; responsive to a reconciliation status from the Private Permissioned Blockchain, verifying via the Interoperability Node whether the party (buyer) has sufficient funds to process the settlement; wherein sending a request to a Custody/Institutional Wallet module initiates the settlement; responsive to a request from the Interoperability Node, sending a signed transaction from the Custody/Institutional Wallet module to a Token Contract on a Public Blockchain; and responsive to a signed transaction from the Custody/Institutional module, executing a transfer of digital assets between the party and the counterparty via the Token Contract on the Public Blockchain.

Exemplary embodiments of the invention can provide a number of advantages. An embodiment of the present invention is directed to minimizing discrepancies and manual errors by providing an end-to-end market application for energy traders to reconcile and settle payments. An embodiment of the present invention is directed to an automated and improved reconciliation, attestation and accelerated settlement process. Transactions may be reconciled through a Reconciliation Smart Contract between two traders. Attestation may leverage data from a third party to achieve consensus. In addition, an embodiment of the present invention may establish a data exchange mechanism that communicates with ETRM (Energy Trading and Risk Management) systems that traders use to enter and update deals and transactions information where pulling that information to a Private Blockchain makes that information available to a smart contract to perform reconciliation between two traders.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a current process flow.

FIG. 2 illustrates a tokenized energy settlements application process flow, according to an exemplary embodiment of the invention.

FIG. 3 is an exemplary architecture diagram, according to an exemplary embodiment of the invention.

FIG. 4 is an illustration of data input fields, according to an embodiment of the present invention.

### DETAILED DESCRIPTION OF EMBODIMENTS

The following description of embodiments provides non-limiting representative examples to particularly describe features and teachings of different aspects of the invention. The embodiments described should be recognized as capable of implementation separately or in combination with other embodiments of the invention.

An embodiment of the present invention is directed to implementing a tokenized energy settlements application. By combining capabilities to automate reconciliation, attest to transactions, and automate payment settlements for the energy industry, an embodiment of the present invention enables party(s) and counterparty(s) to accelerate their post trade processes of transaction reconciliation and payment settlement.

An embodiment of the present invention is directed to a web-based platform that supports oil and gas companies as well as other entities. In this example, the web-based platform provides energy trade deals and transactions reconciliation; energy trade transactions data attestation; and energy trade payment settlements. The various embodiments of the present invention may be applied to various other commodities beyond the energy market.

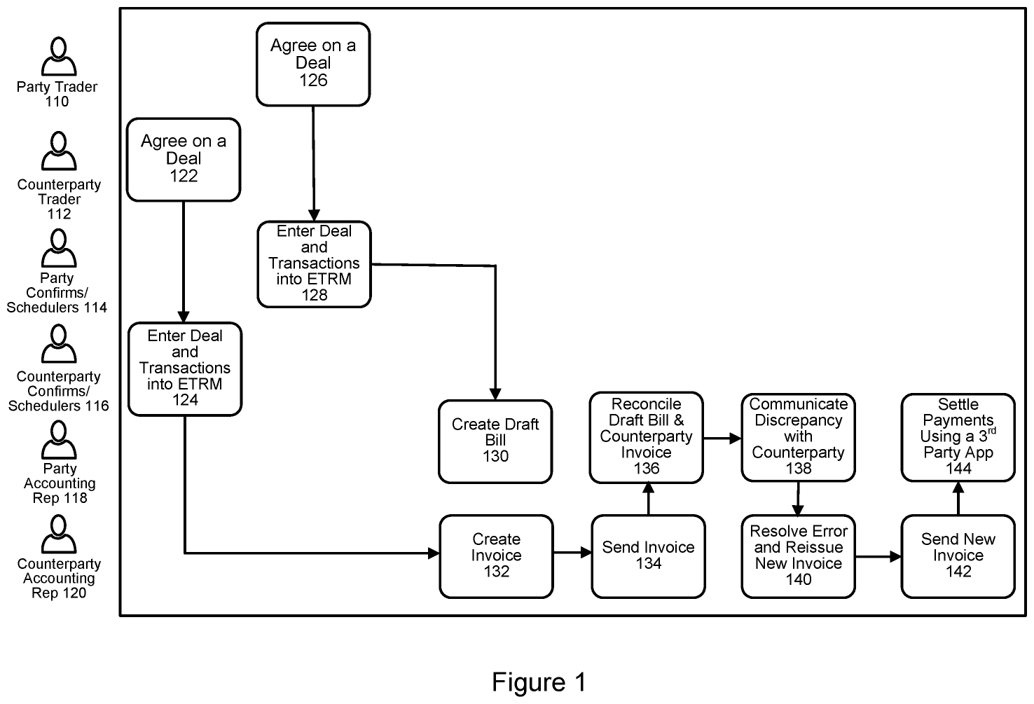

FIG. 1 illustrates a current process flow. As shown in FIG. 1, the process may involve Party Trader 110, Counterparty Trader 112, Party Confirms/Schedulers 114, Counterparty Confirms/Schedulers 116, Party Accounting Representative 118 and Counterparty Accounting Representative 120. As shown in FIG. 1, Party Trader 110 and Counterparty Trader 112 agree on a deal, as shown by 122 and 126. Counterparty Confirms/Schedulers 116 enters the deal and transactions into ETRM at 124. Party Confirms/Schedulers 114 enters deal and transactions into ETRM at 128. Party Accounting Representative 118 creates a draft bill, as shown by 130. Counterparty Accounting Representative 120 creates an invoice at 132. The invoice may be sent at 134. The draft bill and counterparty invoice are reconciled at 136. Any discrepancy can be communicated with counterparty at 138. Errors may be resolved and new invoices may be reissued at 140. The new invoice may be sent at 142. Payments may be settled using a third party application at 144.

Some of the challenges with the current process may include manual reconciliation, delayed settlements, high operating expenses, limited ability to scale and no single source of truth. Accordingly, the current process is manual, labor intensive and requires an extended timeline which significantly delays settlement and payment.

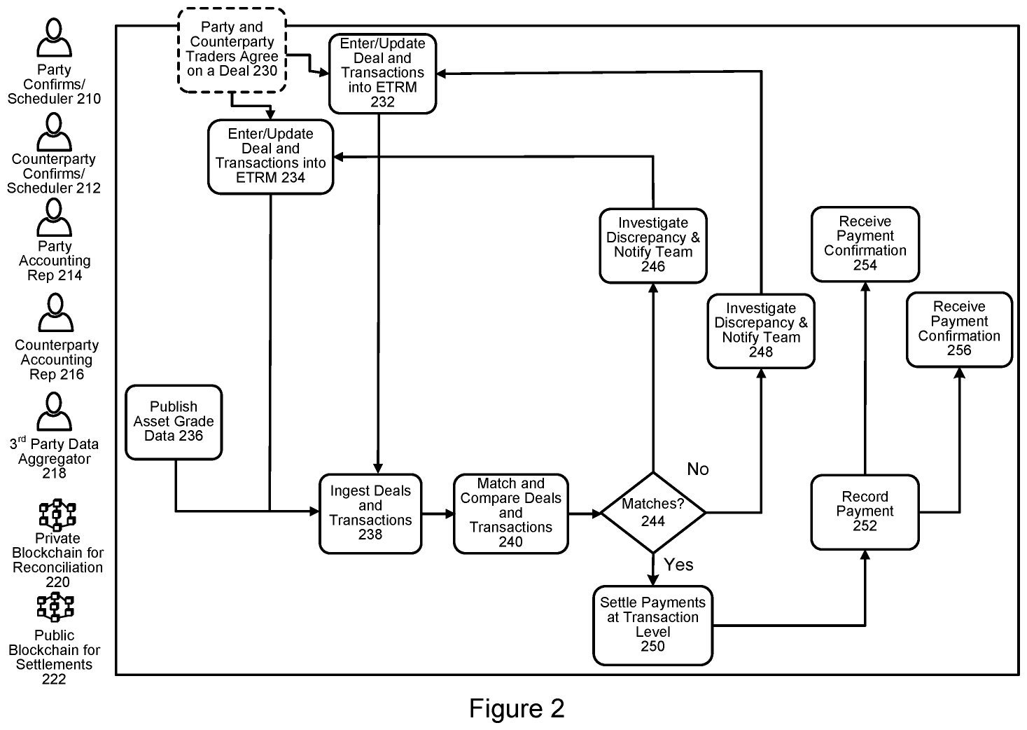

FIG. 2 illustrates a tokenized energy settlements application process flow, according to an exemplary embodiment of the invention. Key benefits include automated reconciliation, real-time settlements, third party data attestation, reduced administrative overhead, fewer manual processes, and audit trail of transactions and payments. Unlike the process in FIG. 1, FIG. 2 involves additional participants, including Third Party Aggregator 218 Private Blockchain 220 and Public Blockchain 222.

At 230, party and counterparty traders may agree on a deal. Party 210 may enter or update deal and transactions into ETRM at 232. Counterparty 212 may enter or update deal and transaction into ETRM at 234. Third party data aggregator 218 may publish authenticated transaction data at 236. Deals and authenticated transaction data may be ingested at 238 by Private Blockchain 220 for reconciliation. Private Blockchain 220 may match and compare deals and transactions at 240. Matches may be determined at 244. If discrepancies are detected, investigation and notification may be performed at 246 and at 248, respectively. If the data matches, payments may be settled at a transaction level at 250 via Public Blockchain 222 for settlements. Payment may be recorded at 252. Payment confirmation may be received at 254 and 256, by accounting representative 214 and 216, respectively.

An embodiment of the present invention is directed to energy trade deals and transactions reconciliation. Smart Contract deployed on the Private-Permissioned Blockchain empowers party(s) and counterparty(s) with a fully automated decentralized reconciliation process. An embodiment of the present invention may periodically ingest confirmed energy trade deals and transactions and automatically reconcile energy trade deals and transactions. In addition, currency exchange rates and commodity exchange rates may be determined for transaction settlements. Further, blockchain may be used to record reconciliation information on a distributed ledger.

An embodiment of the present invention is directed to energy trade transactions data attestation. Energy transactional volumes may be captured from an independent data aggregator that specializes in providing data that is proofed, auditable, and immutable. During the reconciliation process, this authenticated data may be leveraged to attest to the accuracy of transactions submitted by the party and counterparty.

An embodiment of the present invention is directed to providing energy trade payment settlements. For example, a party or a counterparty may settle payments at a transaction granularity instead of waiting for the deal to close or the end of the month. An embodiment of the present invention may further forecast whether a buyer's funds are sufficient to continue trading. Energy deals may be securely settled between party and counterparty on a per transaction basis. Payments may be initiated based on a configurable frequency, such as batch per day/real-time per transaction. An embodiment of the present invention may leverage a disintermediated payments platform like a Public Blockchain to settle payments.

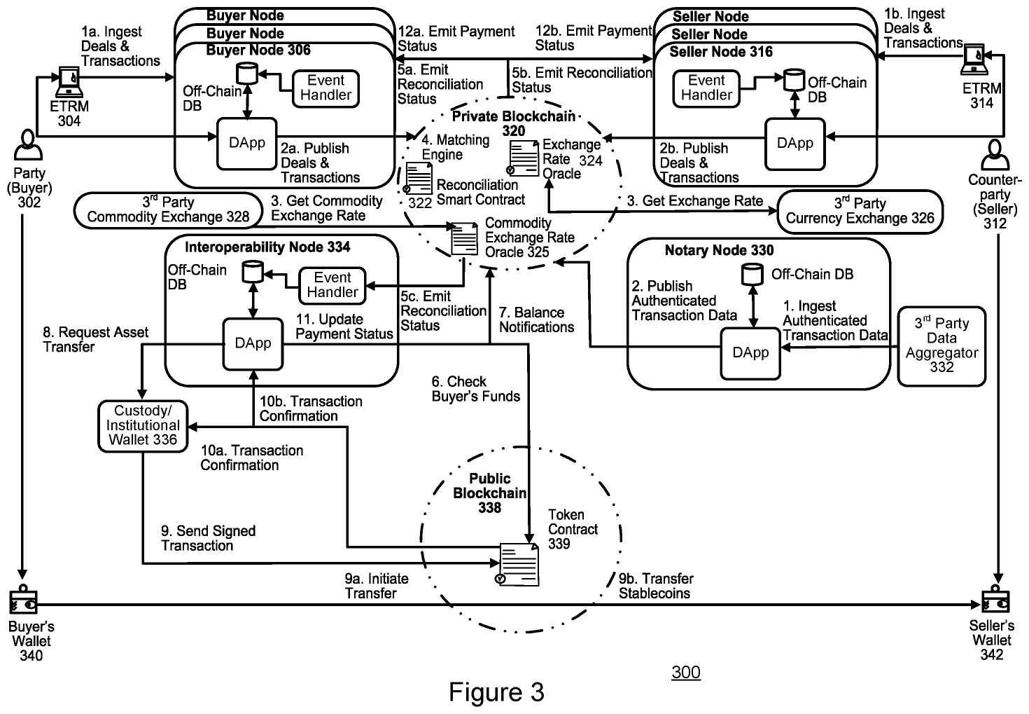

FIG. 3 is an exemplary architecture diagram, according to an exemplary embodiment of the invention. FIG. 3 illustrates an implementation involving Buyer Node 306, Seller Node 316, Notary Node 330, Interoperability Node 334, Private Blockchain 320 and Public Blockchain 338. FIG. 3 provides an exemplary implementation for illustration purposes. The embodiments of the present invention are not limited to this specific example. Other variations may be applied.

Buyer Node (Party) 302 and Seller Node (Counterparty) 312 may represent a separate node per party and counterparty with capabilities to ingest data from ETRM (Energy Trading and Risk Management) systems represented by 304 and 314, validate the transactions, and publish those transactions to Private Blockchain 320. ETRM 304 and 314 represent a source of information for deals and transactions agreed upon by the party and the counterparty.

Notary Node 330 facilitates ingestion of authenticated data from a third-party vendor 332 and publishes relevant party/counterparty' s data to the Private Blockchain 320. This data is used in the reconciliation process to attest to the transactions submitted by the counterparty and party.

Interoperability Node 334 tracks transactions that have been successfully reconciled on Private Blockchain 320 and acts as a bridge to settle the transactions on Public Blockchain 338.

According to an exemplary illustration, each node may include a DApp, Off-Chain Database and/or Event Handler.

DApp represents a decentralized application that provides application users the ability to view and manage the reconciliation and settlement process. For example, User Dashboards identify line items where transaction volumes match versus those that do not and provide pertinent information (e.g., pipeline, flow date, etc.) to accelerate research to resolve the discrepancy.

Off-Chain Database supports DApp's functionality by persisting application metadata, reconciliation and payment events emitted from both the Private and Public Blockchains. Other databases may be supported.

Event Handler represents a service that captures reconciliation status and payment status events emitted from the blockchain.

Private Blockchain 320 represents a permissioned network for the energy industry that places restrictions on who is allowed to participate within the network. Counterparties may need to obtain an invitation or permission to join the network as well as read and write transactions to the shared ledger. Other restrictions may be applied.

Reconciliation Smart Contract 322 may be deployed on Private Blockchain 320 to match deals and transactions submitted by the party and counterparty. Currency Exchange Rate Oracle 324 represents a blockchain service that is used to identify the exchange rate on the day of the transaction to accommodate deals/transactions agreed upon by the counterparties in USD or CAD (and other currencies). Commodity Exchange Rate Oracle 325 represents a blockchain service that is used to identify the agreed upon commodity exchange rate on the day of the transaction in scenarios where the price type is an index price (e.g., NYMEX Natural Gas, etc.).

Reconciliation Smart Contract may reconcile deals and transactions between the parties. When information from both parties match, status information (e.g., successful match) may be communicated. If deals or transactions do not result in a match, the parties may be notified and an investigation may be initiated by an accounting team. With an embodiment of the present invention, reconciliation process is automated and manual work and errors are significantly reduced or even eliminated.

Reconciliation Smart Contract may implement weighted logic that provides varying weights to an attribute in deals/transactions data. This may depend on the entity, application and other variables and conditions. In addition, the Reconciliation Smart Contract may determine a deal/transaction match based on a percentage match (e.g., 90% match).

Third Party Data Aggregator 332 may provide authenticated data that represents trusted pipeline data from an independent data provider. This data may be used in the reconciliation process to attest to the accuracy of the data submitted by the party/counterparty and achieve consensus.

Third Party Currency Exchange 326, may provide currency exchange rates to convert between traditional currencies, e.g., Canadian Dollar to US Dollar.

Third Party Commodity Exchange 328 may provide commodity exchange rates for deals with index prices.

Custody/Institutional Wallet 336 safeguards each counterparty's digital assets and facilitates signing of transactions to initiate payments (or transfer of digital assets) between the party and counterparty.

Token Contract 339 represents a smart contract deployed on Public Blockchain 338 that is responsible for transferring digital assets (e.g., tokens) between the party and counterparty (e.g., USDC token contract).

As shown in FIG. 3, Party (Buyer) 302 may interact with ETRM 304 to enter deals and transactions information. Buyer Node 306 (step la) may interact with the ETRM system to ingest deals and transactions. In a similar manner, Counterparty (Seller) 312 may interact with ETRM 314 to enter deals and transactions information. Seller Node 316 (step 1b) may interact with the ETRM system to ingest deals and transactions. Notary Node 330 (step 1) may interact with the Third Party Data Aggregator 332 to ingest authenticated transaction data. At Notary Node 330, DApp may then publish authenticated transaction data (step 2).

At Buyer Node 306, DApp may publish deals and transactions to Private Blockchain 320 (step 2a). In a similar manner, DApp at Seller Node 316 may publish deals and transactions to Private Blockchain 320 (step 2b). At Notary Node 330, DApp may publish authenticated transaction data to Private Blockchain 320 (step 2c).

At Private Blockchain 320, Currency Exchange Rate Oracle 324 may interact with Third Party Currency Exchange 326 to obtain currency exchange rates (step 3).

At Private Blockchain 320, Commodity Exchange Rate Oracle 325 may interact with Third Party Commodity Exchange 328 to obtain commodity exchange rates, at step 3.

Reconciliation Smart Contract 322 may be deployed on Private Blockchain 320 that hosts business rules to match deals and transactions submitted by the party and counterparty (step 4).

Private Blockchain 320 may emit reconciliation status to Buyer Node 306, Seller Node 316 and Interoperability Node 334 (steps 5a, 5b, 5c). Interoperability Node 334 may check buyer's funds via the Token Contract on Public Blockchain 338 (step 6). Interoperability Node 334 may submit balance notifications to Private Blockchain 320 and as a consequence of that, notifies the buyer (step 7).

Interoperability Node 334 may then request Custody/Institutional Wallet 336 to transfer assets. A signed transaction may then be sent to the Token Contract on Public Blockchain 338 (step 9). In response, the Token Contract on Public Blockchain 338 then initiates transfer from Buyer's Wallet 340 (step 9a) and transfers cryptocurrencies (e.g., stablecoins, etc.) to Seller's Wallet 342 (step 9b).

Transaction confirmation may then be sent from the Token Contract on Public Blockchain 338 to Custody/Institutional Wallet 336 (step 10a) and Interoperability Node 334 (step 10b). Interoperability Node 334 sends the updated payment status (step 11) to Private Blockchain 320 and then the payment status is relayed to the Buyer Node 306 (step 12a) and Seller Node 316 (step 12b).

An embodiment of the present invention is directed to payment settlements. This may involve usage of digital tokens, token infrastructure management and settlements execution. For digital tokens, a tokenized form of currency (e.g., stablecoins, etc.) may be used for payment settlements to avoid lengthy processing times or costly fees involving intermediaries. For Token Infrastructure Management, an embodiment of the present invention may not be responsible for token infrastructure and processes required for origination, distribution, trading, settlement, safekeeping, and redemption. Tokenization may depend on a trusted and credible central authority that guarantees the existence and custody of unique assets backing the tokens issued. For settlements execution, an embodiment of the present invention may leverage a trusted third party commercial issuer of cryptocurrencies (e.g., stablecoins, etc.) on a Public Blockchain (e.g., Circle, etc.) that manages a token contract and the underlying infrastructure for tokens. An embodiment of the present invention, through the Interoperability Node may be responsible for coordinating the execution of transactions (e.g., transfer of funds from party to counterparty) on the Public Blockchain by invoking a Token Contract.

An embodiment of the present invention may not be responsible for digital assets wallets, on-ramp, off-ramp transactions, and frameworks for storing and signing transactions. An embodiment of the present invention is directed to integrating with an institutional digital assets custody solution provider and limited to requesting for transfer of funds from a party to the counterparty and capturing transaction confirmation of the request to transfer funds.

An embodiment of the present invention may support various application workflows and use cases.

An application workflow may relate to energy trade deals and transactions reconciliation. Buyer/Seller Node may ingest deals and transactions and further publish deals and transactions. For example, Buyer (party) and Seller (counterparty) Nodes may be configured to ingest confirmed/updated energy trade deals and transactions from their respective ETRM systems. After retrieving the deals and transactions from the ETRM systems, the information may be validated for data integrity and published to the Private Blockchain. Examples of data integrity checks may include pipeline, location, and organization validations.

Private Blockchain may support a Currency Exchange Rate Oracle to get currency exchange rates. For example, if a deal is agreed upon in CAD (Canadian Dollar) but it is to be settled in USD (US Dollar), the Currency Exchange Rate Oracle smart contract may retrieve the exchange rate on the day of the transaction and maintain a record of it for transaction settlements.

Private Blockchain may support a Commodity Exchange Rate Oracle to get commodity exchange rates. For example, if a deal is agreed upon in an indexed price such as NYMEX Natural Gas, the Commodity Exchange Rate Oracle smart contract may retrieve the commodity exchange rate on the day of the transaction and maintain a record of it for transaction settlements.

Reconciliation Smart Contract deployed on a Private Blockchain may match the information within deals and transactions submitted by the party and counterparty. After the matching process, information of the reconciliation process is stored on the Private Blockchain and may proceed to notifying the reconciliation status to party, counterparty, Interoperability Node. Interoperability Node may be notified in case of a successful reconciliation. In case of a mismatch, authenticated transaction data provided by the Notary Node may be used to attest to the accuracy of the transactions submitted by the party/counterparty and achieve consensus.

An application workflow may relate to energy trade transactions data attestation. The Notary Node may be configured to periodically ingest the party's and counterparty's energy transactional volumes from an independent data aggregator. After retrieving transaction volumes from an independent data aggregator, the data may be transformed for consumption and published to the Private Blockchain. As noted above, the authenticated transaction data may be used during reconciliation to attest to the accuracy of the transactions submitted by the party and counterparty.

An application workflow may relate to energy trade payment settlements. Interoperability Node may emit reconciliation status, check buyer's funds, provide insufficient balance notification, and emit updated payment status.

In the case of a successful transaction reconciliation, the Interoperability Node may capture the reconciliation status emitted from the Private Blockchain and begin the settlement process.

Interoperability Node may resolve the buyer's digital wallet address and invoke the Token contract on the Public Blockchain to get the current funds balance. The Interoperability Node may then compare funds available within the buyer's (party) wallet to funds to be disbursed to the seller (counterparty). The Interoperability Node may also forecast whether a buyer has sufficient funds to continue trading for fixed price deals that are due to be executed in the near-future.

An insufficient balance notification may be sent to the buyer if funds available within the buyer's wallet are not sufficient to process the payment.

A request to transfer funds from the buyer's wallet to the seller's wallet may be created if funds available within the buyer's wallet can partially or fully settle the reconciled transaction.

Details of the payment settlement may be recorded on the Private Blockchain. The party and counterparty may be notified of a change in payment status.

Upon receipt of a request from the Interoperability Node to transfer assets, the Custody/Institutional Wallet module may prepare and send a signed transaction to a stablecoin's Token Contract (e.g., USDC Coin Contract, etc.). Acting upon the transaction, the Token Contract may initiate the transfer of funds from the buyer (9a) to the seller (9b).

A transaction confirmation from the Token Contract may be relayed back to the Custody/Institutional Wallet module and to the Interoperability Node.

An embodiment of the present invention is directed to energy trade deals and transactions reconciliation. This may involve providing party(s) and counterparty(s) with a fully-automated decentralized reconciliation process through the Reconciliation Smart Contract. An embodiment of the present invention may periodically ingest confirmed energy trade deals and transactions from ETRMs; automatically match energy trade deals and transactions based on business rules; leverage currency exchange rates to determine transaction settlements value and record reconciliation information on a distributed ledger like the Private Blockchain.

An embodiment of the present invention is directed to energy trade transactions data attestation. An embodiment of the present invention may capture energy transactional volumes from an independent data aggregator that specializes in providing data that is proofed, auditable, and immutable. In addition, an embodiment of the present invention may leverage this data to attest to the accuracy of transactions submitted by the party and counterparty. For example, in the event of a data discrepancy between transaction volumes submitted by a party and a counterparty, if the transaction volume from the third party data aggregator matches either the party or counterparty' s volumes, it may be used to resolve the discrepancy.

An embodiment of the present invention is directed to energy trade payment settlements. This may involve providing party(s) and counterparty(s) the ability to settle payments at a transaction granularity instead of waiting for the end of the month to generate and settle an invoice.

An embodiment of the present invention may forecast whether a buyer's (party) funds are sufficient to continue trading; securely settle energy deals between party and counterparty on a per transaction basis; initiate payments based on a configurable frequency-batch per day/real-time per transaction; and leverage a disintermediated payments platform like the Public Blockchain to settle payments.

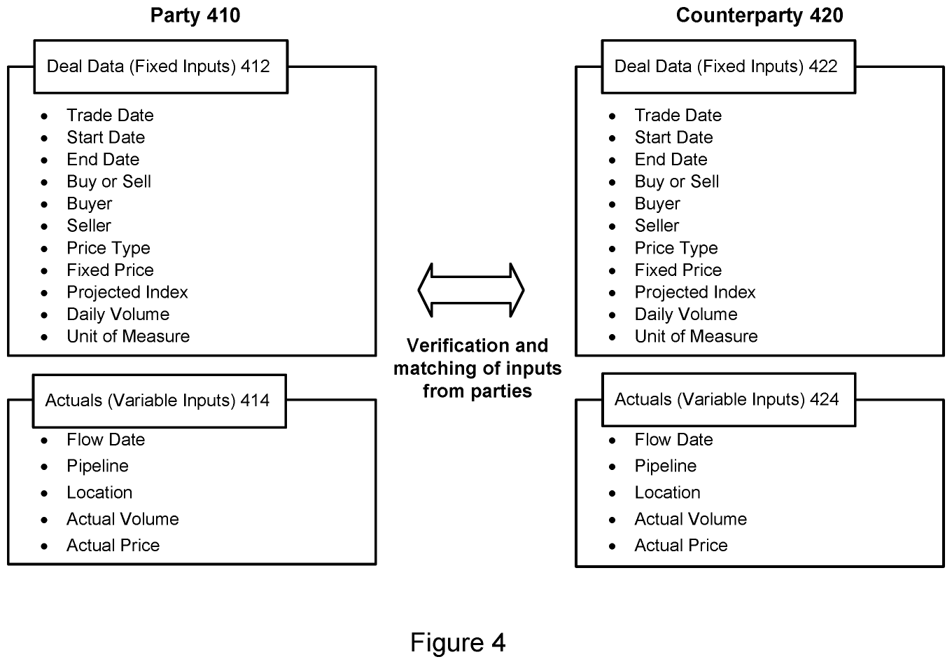

FIG. 4 is an illustration of data input fields, according to an embodiment of the present invention. As shown in FIG. 4, Party 410 may submit or otherwise identify a set of deal data 412. Deal data may be fixed inputs. Exemplary deal data may include Trade Date, Start Date, End Date, Buy or Sell, Buyer, Seller, Price Type, Fixed Price, Projected Index, Daily Volume, Unit of Measure, etc. Actuals 414 may represent variable inputs. Exemplary actuals may include flow date, pipeline, location, actual volume, actual price, etc.

Counterparty 420 may identify corresponding Deal Data 422 and Actuals 424. An embodiment of the present invention may provide verification and matching of inputs from parties.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements. For example, although the various embodiments described herein refer to blockchains and blockchain-related technology, the invention is not limited to such embodiments but, rather, can be used with any distributed ledger technology.

The system described above can be implemented with servers and other computing devices in various configurations. The various servers and computing devices may use software to execute programs to execute the methods described above. Various embodiments of the invention also relate to the software or computer readable medium containing program instructions for executing the above described methods.

Although the foregoing examples show the various embodiments of the invention in one physical configuration; it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

Communications networks connect the various computing devices described above and may be comprised of, or may interface to any one or more of, for example, the Internet, an intranet, a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34b which is an analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The communications networks that connect the various computing devices described above may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a GPS link, a cellular digital packet data (CDPD) link, a Research in Motion, Limited (RIM) duplex paging type device, a Bluetooth radio link, or an IEEE 802.11-based radio frequency link. Communications networks may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, the communication networks may comprise a satellite communications network, such as a direct broadcast communication system (DBS) having the requisite number of dishes, satellites and transmitter/receiver boxes, for example. The communications network may also comprise a telephone communications network, such as the Public Switched Telephone Network (PSTN). In another embodiment, communication networks may comprise a Personal Branch Exchange (PBX), which may further connect to the PSTN.

Although examples of servers and personal computing devices are described above, exemplary embodiments of the invention may utilize other types of communication devices whereby a user may interact with a network that transmits and delivers data and information used by the various systems and methods described herein. The personal computing devices may include desktop computers, laptop computers, tablet computers, smart phones, and other mobile computing devices, for example. The servers and personal computing devices may include a microprocessor, a microcontroller or other device operating under programmed control. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art. The personal computing devices may be equipped with an integral or connectable liquid crystal display (LCD), electroluminescent display, a light emitting diode (LED), organic light emitting diode (OLED) or another display screen, panel or device for viewing and manipulating files, data and other resources, for instance, using a graphical user interface (GUI) or a command line interface (CLI). The personal computing devices may also include a network-enabled appliance or another TCP/IP client or other device. The personal computing devices may include various connections such as a cell phone connection, WiFi connection, Bluetooth connection, satellite network connection, and/or near field communication (NFC) connection, for example.

The servers and personal computing devices described above may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software. The modules described above may comprise software, firmware, hardware, or a combination of the foregoing.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers and personal computing devices described above may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript and others. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

In the system and method of exemplary embodiments of the invention, a variety of “user interfaces” may be utilized to allow a user to interface with the personal computing devices. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. A system for implementing a tokenized energy settlements application, the system comprising:
i) a first sub-system configured to capture energy deals and transactions information from both party and counterparty source systems and further configured to reconcile the information, the first sub-system comprising:
a node executing software that ingests a first set of data and transactions from a party's (buyer) Energy Trading and Risk Management (ETRM) system;
a node executing software that ingests a second set of data and transactions from a counterparty's (seller) ETRM system;
a Private Permissioned Blockchain that receives deals and transactions data from the party; deals and transactions data from the counterparty; authenticated transaction data from a Notary Node; currency exchange rate data through a Currency Exchange Rate Oracle; and commodity exchange rate data through a Commodity Exchange Rate Oracle; and
a Reconciliation Smart Contract that matches deals and transactions submitted by the party and the counterparty using the authenticated transaction data from the Notary Node to achieve consensus and emits reconciliation status to the party, the counterparty, and an Interoperability Node;
ii) a second sub-system configured to attest to the data submitted by the party and the counterparty; the second sub-system comprising:
the Notary Node configured to ingest authenticated transaction data from a third-party data aggregator;
iii) a third sub-system configured to support payment settlements on a Public Blockchain; the third sub-system comprising:
the Interoperability Node that, in response to a successful transaction reconciliation, initiates a settlement process; verifies whether the party (buyer) has sufficient funds to process the settlement; and notifies the party (buyer) of a corresponding balance; and
a Custody/Institutional Wallet module configured to send a signed transaction to a Token Contract on the Public Blockchain, responsive to a request from the Interoperability Node;
wherein responsive to a signed transaction from the Custody/Institutional module, the Token Contract on the Public Blockchain effectuates the settlement between the party and the counterparty.

2. The system of claim 1, wherein the deals and transactions information from the ETRM systems are published to a Private Permissioned Blockchain.

3. The system of claim 1, wherein the authenticated transaction data from a third-party data aggregator is published to a Private Permissioned Blockchain.

4. The system of claim 1, wherein the Reconciliation Smart Contract is deployed on the Private Permissioned Blockchain to reconcile one or more deals between a party and a counterparty.

5. The system of claim 1, wherein the Interoperability Node acts as a bridge by capturing the reconciled transactions on the Private Permissioned and initiating the settlement process for those transactions on the Public Blockchain.

6. The system of claim 1, wherein the Interoperability Node integrates with a Custody/Institutional Wallet module to transfer assets between the party and counterparty.

7. A method for implementing a tokenized energy settlements application, the method comprising the steps of:
ingesting a first set of data and transactions from a party's (buyer) Energy Trading and Risk Management (ETRM) system;
ingesting a second set of data and transactions from a counterparty's (seller) ETRM system;
ingesting authenticated transaction data from a third-party data aggregator;
publishing to a Private Permissioned Blockchain deals and transactions data from the party; deals and transactions data from the counterparty; the authenticated transaction data from the third-party data aggregator; currency exchange rate data through a Currency Exchange Rate Oracle; commodity exchange rate data through a Commodity Exchange Rate Oracle;
reconciling deals and transactions via a Reconciliation Smart Contract;
using authenticated transaction data from the third-party data aggregator to achieve consensus;
emitting reconciliation status to the party, the counterparty, and an Interoperability Node;
responsive to a reconciliation status from the Private Permissioned Blockchain, verifying via the Interoperability Node whether the party (buyer) has sufficient funds to process the settlement; wherein sending a request to a Custody/Institutional Wallet module initiates the settlement;
responsive to a request from the Interoperability Node, sending a signed transaction from the Custody/Institutional Wallet module to a Token Contract on a Public Blockchain; and
responsive to a signed transaction from the Custody/Institutional module, executing a transfer of digital assets between the party and the counterparty via the Token Contract on the Public Blockchain.

8. The method of claim 7, wherein the deals and transactions information from the ETRM systems are published to a Private Permissioned Blockchain.

9. The method of claim 7, wherein the authenticated transaction data from a third-party data aggregator is published to a Private Permissioned Blockchain.

10. The method of claim 7, wherein the Reconciliation Smart Contract is deployed on the Private Permissioned Blockchain to reconcile one or more deals between a party and a counterparty.

11. The method of claim 7, wherein the Reconciliation Smart Contract applies a weighted logic to one or more attributes of the deals and transactions information submitted by the party and counterparty to determine a match.

12. The method of claim 7, wherein the authenticated transaction data from a third-party data aggregator is used to attest to the information submitted by the party and counterparty.

13. The method of claim 7, wherein the Interoperability Node captures the status of the transactions being reconciled on the Private Blockchain.

14. The method of claim 7, wherein the Interoperability Node invokes the Token Contract on the Public Blockchain to identity balance and make a determination if a payment settlement can be initiated.

15. The method of claim 7, wherein the Interoperability Node creates a request for the Custody/Institutional Wallet module to transfer assets between the party and the counterparty.

16. The method of claim 7, wherein the Custody/Wallet module sends a signed transaction to the Token Contract on the Public Blockchain.

17. The method of claim 7, wherein the Token Contract on the Public Blockchain executes the transfer of digital assets between the party and the counterparty.

18. The method of claim 7, wherein the Custody/Institutional Wallet module captures the transaction confirmation from the Token Contract and forwards the confirmation to the Interoperability Node.

19. The method of claim 7, wherein the Interoperability Node sends the payment settlement status for a particular transaction to the Private Blockchain.

20. The method of claim 7, wherein the payment status is communicated to the party and the counterparty through the Private Blockchain.

21. A system for implementing a tokenized energy settlements application, the system comprising:
i) a first sub-system configured to capture energy deals and transactions information from both party and counterparty source systems and further configured to reconcile the information, the first sub-system comprising;
a node executing software that ingests a first set of data and transactions from a party's (buyer) Energy Trading and Risk Management (ETRM) system;
a node executing software that ingests a second set of data and transactions from a counterparty's (seller) ETRM system;
a Private Permissioned Blockchain that receives deals and transactions data from the party; deals and transactions data from the counterparty; and authenticated transaction data from a Notary Node; and
a Reconciliation Smart Contract that matches deals and transactions submitted by the party and the counterparty using the authenticated transaction data from the Notary Node to achieve consensus and emits reconciliation status;
ii) a second sub-system configured to attest to the data submitted by the party and the counterparty; and
iii) a third sub-system configured to support payment settlements on a Public Blockchain.
